(19) United States
(12) Patent Application Publication
(10) Pub. No.: US 2015/0348130 A1
(43) Pub. Date: Dec. 3, 2015

(54) SYSTEMS AND METHODS FOR MANAGING COMPLIANCE WITH ONE OR MORE MINIMUM ADVERTISED PRICING POLICIES

(71) Applicant: Viesoft, Inc., San Francisco, CA (US)

(72) Inventor: Anthony Vierra, San Francisco, CA (US)

(21) Appl. No.: 14/477,108

(22) Filed: Sep. 4, 2014

Related U.S. Application Data
(60) Provisional application No. 62/006,233, filed on Jun. 1, 2014.

(51) Int. Cl. G06Q 30/02

(52) U.S. Cl. CPC G06Q 30/0273

(57) ABSTRACT

A system and method that is configured to: (1) communicate from a manufacturer to one or more retailers a minimum advertised pricing policy, (2) update the minimum advertised pricing policy in real-time, (3) allow a retailer to check whether a current or proposed price violates the manufacturer's current minimum advertised pricing policy; and (4) allow the retailer to determine if a competitor is violating the manufacturer's current minimum advertised pricing policy. In various embodiments, the retailer can report a competitor's violation of the manufacturer's current minimum advertised pricing policy and the system is further configured to allow the manufacturer and competitor to communicate and resolve the potential manufacturer's current minimum advertised pricing policy violation.

### CROSS-REFERENCE TO RELATED APPLICATIONS

This application claims the benefit of priority to U.S. Non-Provisional application Ser. No. 62/006,233, entitled Systems and Methods for Managing Compliance with One or More Minimum Advertised Pricing Policies, filed Jun. 1, 2014. This application is hereby incorporated by reference in its entirety.

### BACKGROUND

In general, manufacturers set minimum advertised price (“MAP”) policies in an effort to main consistency in pricing. Typically, there are no structured ways to communicate current MAP policies or updates to these MAP policies to retailers of the manufacturer's products. In addition, manufacturers may or may not have effective programs for policing MAP policies. Thus, if MAP policies are not effectively enforced, complying retailers may become disgruntled and may even potentially stop complying. Currently, it takes manufacturers significant time and effort to police, monitor, and enforce MAP policies. Also, it takes retailers a significant amount of time and effort to stay up to date and to comply with various manufacturers' individual MAP policies.

### SUMMARY

In general, in various embodiments, a computer system for managing compliance with one or more MAP policies includes at least one processor and memory, wherein the computer system is configured for: (1) receiving a first set of data that includes MAP information for a particular product made by a manufacturer, the MAP information reflecting at least a portion of a MAP policy established by the manufacturer; (2) storing the first set of data in the memory; (3) receiving a request from a user to confirm that a particular price for the particular product complies with the MAP policy; (4) at least partially in response to receiving the request, using the first set of data to determine whether the particular price for the particular product complies with the MAP policy; (5) at least partially in response to determining that the particular price for the particular product complies with the MAP policy, informing the user that the particular price for the particular product complies with the MAP policy; and (6) at least partially in response to determining that the particular price for the particular product does not comply with the MAP policy, informing the user that the particular price for the particular product does not comply with the MAP policy.

In an illustrative embodiment, a method of enforcing a MAP policy includes (1) providing access, by a plurality of retailers and at least one manufacturer, to a centralized computer system; (2) receiving, via the computer system, an indication by a first one of the retailers that a second one of the retailers has potentially violated a MAP policy associated with the manufacturer; (3) at least partially in response to the computer system receiving the indication, using the computer system to inform the manufacturer that the second retailer has potentially violated a MAP policy; and (4) using the computer system to facilitate communication between the second retailer and the manufacturer regarding the second retailer's potential violation of the MAP policy.

In an illustrative embodiment, a computer system for managing compliance with one or more MAP policies includes at least one processor and memory, wherein the computer system is configured for: (1) receiving a first set of data that includes MAP information for a particular product made by a manufacturer, the MAP information reflecting at least a portion of a MAP policy established by the manufacturer; (2) at least partially in response to receiving the first set of data, storing the first set of data in the memory and transmitting the first set of data to a plurality of retailers that are currently selling the product; (3) receiving a second set of data that includes updated MAP information for the particular product; and (4) at least partially in response to receiving the second set of data, storing the second set of data in the memory and transmitting the second set of data to a plurality of retailers that are currently selling the product.

In an illustrative embodiment, a computer system for managing compliance with one or more MAP policies includes at least one processor and memory, wherein the computer system is configured for: (1) receiving a first set of data that includes MAP information for a particular product made by a manufacturer, the MAP information reflecting at least a portion of a MAP policy established by the manufacturer; (2) storing the first set of data in the memory; (3) receiving pricing data for the particular product from a website associated with a particular retailer; (4) at least partially in response to receiving the pricing data, using the first set of data to determine whether the particular price for the particular product complies with the MAP policy; and (5) at least partially in response to determining that the particular price for the particular product does not comply with the MAP policy, informing the particular retailer that the particular price for the particular product does not comply with the MAP policy.

### BRIEF DESCRIPTION OF THE DRAWINGS

Various embodiments of a system and method for managing compliance with one or more MAP policy are described below. In the course of this description, reference will be made to the accompanying drawings, which are not necessarily drawn to scale, and wherein:

FIG. 1 is a block diagram of a MAP compliance server in accordance with an embodiment of the present system;

FIG. 2 is a schematic diagram of a computer, such as the MAP compliance server of FIG. 1, that is suitable for use in various embodiments;

FIG. 3 depicts a flow chart that generally illustrates various steps executed by a MAP compliance communication module that, for example, may be executed by the MAP compliance server of FIG. 1;

FIG. 4 depicts a flow chart that generally illustrates various steps executed by a MAP compliance policing module that, for example, may be executed by the MAP compliance server of FIG. 1;

FIG. 5 depicts a flow chart that generally illustrates various steps executed by a MAP compliance reporting and enforcing module that, for example, may be executed by the MAP compliance server of FIG. 1;

FIG. 6 depicts a flow chart that generally illustrates various steps executed by a MAP compliance monitoring module that, for example, may be executed by the MAP compliance server of FIG. 1;

FIG. 7 depicts an example of a user interface showing a particular retailer's price grid that tracks and displays MAP compliance; and

FIG. 8A-8C depict examples of a user interface that allow a retailer to check pricing against a manufacturer's MAP, check competitor pricing against a manufacturer's MAP and submit potential MAP violations to the manufacturer.

### DETAILED DESCRIPTION

Various embodiments now will be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview

A MAP compliance system according to various embodiments is adapted to: (A) facilitate communication of MAP information between manufacturers and retailers; (B) facilitate policing of current MAP policies by both manufacturers and retailers; (C) encourage compliance with current MAP policies; and (D) facilitate communication between retailers who are allegedly violating current MAP policies in order to either end the violation of the policies or to resolve a misunderstanding, on behalf of the manufacturer, that the retailer is in violation of a MAP policy when, in fact, no violation has occurred.

In particular embodiments, in facilitating the communication of MAP information between manufacturers and retailers, the system is adapted to receive a first set of data about a particular MAP for a particular product. The MAP information will include information such as the specific product, the specific price, and other information related to when and how the price can be changed. After receiving the MAP information, the system is adapted to store the MAP information and transmit this information to all retailers currently selling the particular product. If the manufacturer updates the MAP policy for a particular product, the system will receive a second set of data that includes the updated MAP information. As with the first set of data, the system will store and transmit the information pertaining to the second set of data directly to the retailers currently selling the particular product. This information may be transmitted via electronic communication such as an instant message, email, or a pop-up notification on the retailer's computer.

The system is also adapted to receive requests from the retailers to verify current or proposed pricing schedules for a particular product. The retailers may also verify pricing schedules of competitors that are also using the system. In verifying these pricing schedules, the system will first receive data relating to the current MAP for a particular product from a manufacturer and store this data until a request has been made by a retailer. Once the retailer makes a request to confirm the pricing schedule, the system will compare the retailer's price with the MAP, as stated by the manufacturer. If the retailer's price is above or equal to the MAP, the system will notify the retailer that the retailer's price complies with the manufacturer's MAP. However, if the retailer's price is below the MAP, the system will notify the retailer that the retailer's price does not comply with the manufacturer's MAP.

The system is further adapted to allow retailers to police other retailers' pricing activities. For example, one retailer may use the system to determine whether its competitor is meeting or exceeding the MAP set by the manufacturer for a particular product sold by the retailers. If the competitor's price is lower than the manufacturer's MAP, the retailer may use the system to notify the manufacturer that the competitor's price does not comply with the manufacturer's MAP. The system may then allow the competitor and the manufacturer to resolve the discrepancy and potentially notify other retailers of the resolution.

In addition, the system is further adapted to permit manufacturers to police retailers' pricing activities for particular products. For example, the system will receive a particular retailer's price for a particular product directly from the retailer's website. After receiving the information from the retailer's website, the system may send a notification to the retailer stating that the retailer's price for the particular product either does or does not comply with the manufacturer's MAP policy. In addition, the system may inform the manufacturer of non-complying retailers.

### Exemplary Technical Platforms

As will be appreciated by one skilled in the relevant field, the present invention may be, for example, embodied as a computer system, a method, or a computer program product. Accordingly, various embodiments may take the form of an entirely hardware embodiment, or an embodiment combining software and hardware aspects. Furthermore, particular embodiments may take the form of a computer program product stored on a computer-accessible storage medium having computer-readable instructions (e.g., software) embodied in the storage medium. Various embodiments may take the form of web-implemented computer software. Any suitable computer-accessible storage medium may be utilized including, for example, hard disks, compact disks, DVDs, optical storage devices, and/or magnetic storage devices.

Various embodiments are described below with reference to block diagrams and flowchart illustrations of methods, apparatuses (e.g., systems) and computer program products. It should be understood that each block of the block diagrams and flowchart illustrations, and combinations of blocks in the block diagrams and flowchart illustrations, respectively, can be implemented by a computer executing computer program instructions (e.g., a computer-implemented method). These computer program instructions may be loaded onto a general purpose computer, special purpose computer, or other programmable data processing apparatus to produce a machine, such that the instructions which execute on the computer or other programmable data processing apparatus to create means for implementing the functions specified in the flowchart block or blocks.

These computer program instructions may also be stored in a computer-readable memory that can direct a computer or other programmable data processing apparatus to function in a particular manner such that the instructions stored in the computer-readable memory produce an article of manufacture that is configured for implementing the functions specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions.

### Example System Architecture

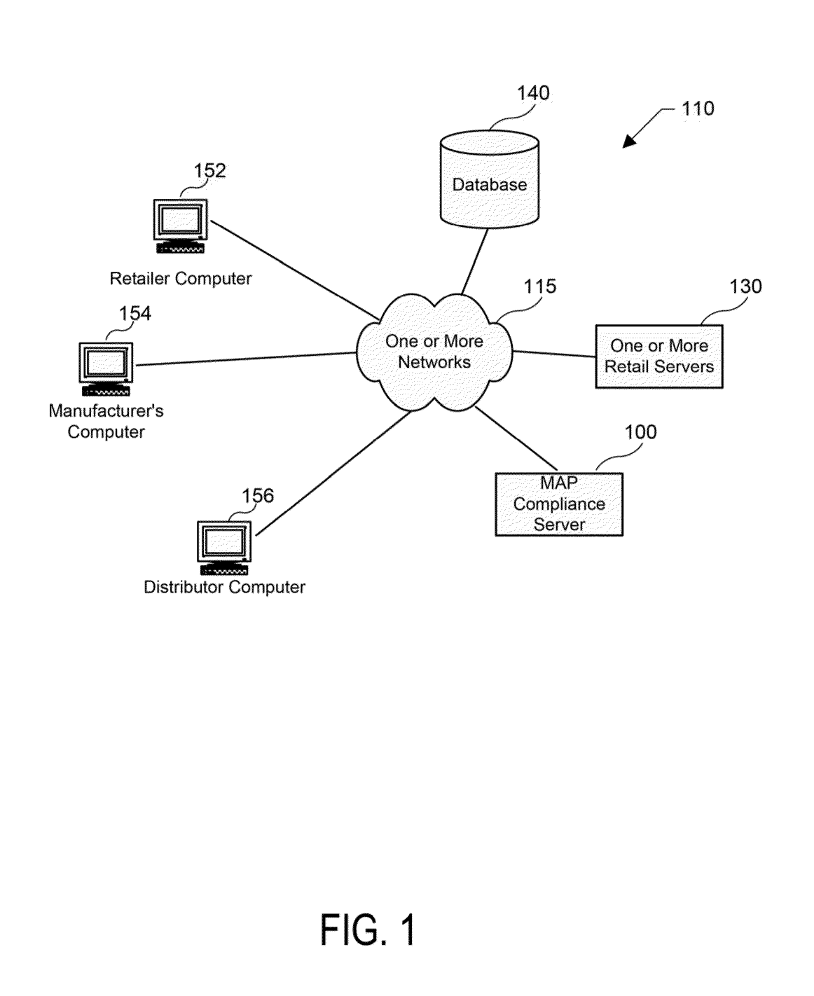

FIG. 1 is a block diagram of a System 110 according to a particular embodiment. As may be understood from this figure, the System 110 includes one or more computer networks 115, a MAP Compliance Server 100, One or More Retail Servers 130, a Database 140, and one or more computing devices such as a retailer computer 152 (e.g., such as a smart phone, a tablet computer, a wearable computing device, a laptop computer, etc.), a manufacturer's computer 154, or a distributor's computer 156. In particular embodiments, the one or more computer networks 115 facilitate communication between the MAP Compliance Server 100, One or More Retail Servers 130, the Database 140, and the one or more computing devices 152, 154, 156.

The one or more computer networks 115 may include any of a variety of types of wired or wireless computer networks such as the Internet, a private intranet, a mesh network, a public switch telephone network (PSTN), or any other type of network (e.g., a network that uses Bluetooth or near field communications to facilitate communication between computers). The communication link between the MAP Compliance Server 100 and Database 140 may be, for example, implemented via a Local Area Network (LAN) or via the Internet.

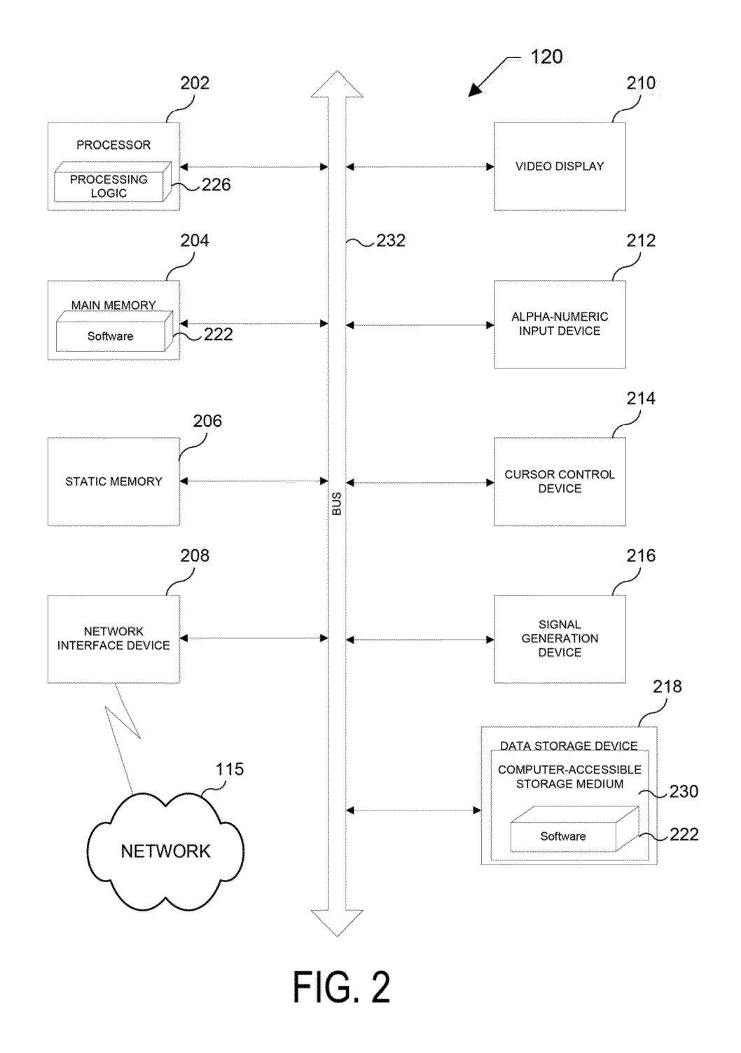

FIG. 2 illustrates a diagrammatic representation of a computer 120 that can be used within the System 110, for example, as a client computer (e.g., one of the computing devices 152, 154, 156 shown in FIG. 1), or as a server computer (e.g., MAP Compliance Server 100 shown in FIG. 1). In particular embodiments, the computer 120 may be suitable for use as a computer within the context of the System 110 that is configured for collecting, tracking, and storing MAP compliance data.

In particular embodiments, the computer 120 may be connected (e.g., networked) to other computers in a LAN, an intranet, an extranet, and/or the Internet. As noted above, the computer 120 may operate in the capacity of a server or a client computer in a client-server network environment, or as a peer computer in a peer-to-peer (or distributed) network environment. The Computer 120 may be a desktop personal computer (PC), a tablet PC, a set-top box (STB), a Personal Digital Assistant (PDA), a cellular telephone, a web appliance, a server, a network router, a switch or bridge, or any other computer capable of executing a set of instructions (sequential or otherwise) that specify actions to be taken by that computer. Further, while only a single computer is illustrated, the term “computer” shall also be taken to include any collection of computers that individually or jointly execute a set (or multiple sets) of instructions to perform any one or more of the methodologies discussed herein.

An exemplary computer 120 includes a processing device 202, a main memory 204 (e.g., read-only memory (ROM), flash memory, dynamic random access memory (DRAM) such as synchronous DRAM (SDRAM) or Rambus DRAM (RDRAM), etc.), a static memory 206 (e.g., flash memory, static random access memory (SRAM), etc.), and a data storage device 218, which communicate with each other via a bus 232.

The processing device 202 represents one or more general-purpose or specific processing devices such as a microprocessor, a central processing unit, or the like. More particularly, the processing device 202 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processing device 202 may also be one or more special-purpose processing devices such as an application specific integrated circuit (ASIC), a field programmable gate array (FPGA), a digital signal processor (DSP), network processor, or the like. The processing device 202 may be configured to execute processing logic 226 for performing various operations and steps discussed herein.

The computer 120 may further include a network interface device 208. The computer 120 also may include a video display unit 210 (e.g., a liquid crystal display (LCD) or a cathode ray tube (CRT)), an alphanumeric input device 212 (e.g., a keyboard), a cursor control device 214 (e.g., a mouse), and a signal generation device 216 (e.g., a speaker).

The data storage device 218 may include a non-transitory computer-accessible storage medium 230 (also known as a non-transitory computer-readable storage medium or a non-transitory computer-readable medium) on which is stored one or more sets of instructions 222 (e.g., MAP Compliance Communications Module 300, MAP Compliance Policing Module 400, MAP Compliance Reporting & Enforcing Module 500, and MAP Price Compliance Monitoring Module 600) embodying any one or more of the methodologies or functions described herein. The software 222 may also reside, completely or at least partially, within the main memory 204 and/or within the processing device 202 during execution thereof by the computer 120—the main memory 204 and the processing device 202 also constituting computer-accessible storage media. The software 222 may further be transmitted or received over a network 115 via a network interface device 208.

While the computer-accessible storage medium 230 is shown in an exemplary embodiment to be a single medium, the terms “computer-accessible storage medium” and “computer-readable medium” should be understood to include a single medium or multiple media (e.g., a centralized or distributed database, and/or associated caches and servers) that store the one or more sets of instructions. The terms “computer-accessible storage medium” and “computer-readable medium” should also be understood to include any medium (e.g., non-transitory medium) that is capable of storing, encoding or carrying a set of instructions for execution by the computer and that cause the computer to perform any one or more of the methodologies of the present invention. The terms “computer-accessible storage medium” and “computer-readable medium” should accordingly be understood to include, but not be limited to, solid-state memories, optical and magnetic media, etc.

### Exemplary System Methods

As noted above, a MAP Compliance System according to various embodiments is adapted to perform a variety of different functions relating to MAP compliance and the resolution of violations of MAP policies. It should be understood by reference to this disclosure that the methods describe an exemplary embodiments of method steps carried out by the present system, and that other exemplary embodiments may be created by adding other steps, by removing one or more of the method steps, or performing one or more of the method steps in an order other than the order in which they described in Figures. Exemplary functionality of certain embodiments of the system is described below.

### MAP Compliance Communication Module

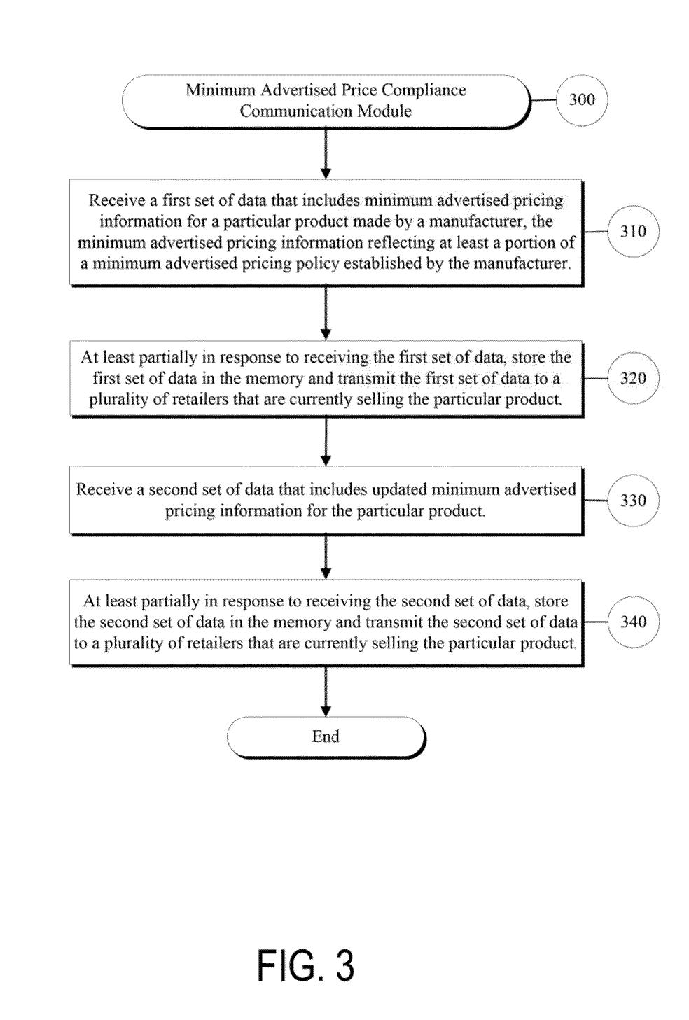

FIG. 3 is a flow chart of operations performed by an exemplary MAP Compliance

Communication Module 300, which may, for example, run on the MAP Compliance Server 100, or any suitable computing device (such as a suitable mobile computing device). In particular embodiments, the MAP Compliance Communication Module 300 may facilitate the storing and distributing of MAP compliance data.

In various embodiments, the system begins at Step 310 by receiving a first set of data that includes MAP information for a particular product made by a manufacturer, the MAP information reflecting at least a portion of a MAP policy established by the manufacturer. In particular embodiments, the system may be configured to receive the first set of data from any suitable computing device. In various embodiments, the MAP policy may, for example, have been established by a manufacturer of the particular product. The MAP policy may include MAP information for one or more products made by the manufacturer. The MAP information may include information such as price, date, geographic area, etc. for the MAP of a particular product. In particular embodiments, the MAP information may include, for example, a MAP for the particular product for a particular geographical area. In various embodiments, the MAP information may include, for example, a MAP for the particular product for a particular time period. For example, the MAP for a particular product may be set at $100 for the period between June 1 and July 31 and $85 for the period between August 1 and September 30.

Next, at Step 320, the system continues by, at least partially in response to receiving the first set of data, storing the first set of data in the memory and transmitting the first set of data to a plurality of retailers that are currently selling the particular product. In various embodiments, the system may be configured to substantially automatically store and transmit the first set of data to the plurality of retailers. In particular embodiments, the system may be configured to transmit the first set of data on a particular date, for example, the first day of every month.

At Step 330, the system receives a second set of data that includes updated MAP information for the particular product. For example, the updated MAP information for the particular product may raise the MAP from $100 to $110 due to high demand for the particular product. In various embodiments, the second set of data may include any suitable change to the first set of data, including changes to price, date, geographic area, etc. for the MAP of the particular product.

Continuing to Step 340, the system, at least partially in response to receiving the second set of data, stores the second set of data in the memory and transmits the second set of data to a plurality of retailers that are currently selling the particular product. In various embodiments, the system may be configured to substantially automatically store and transmit the second set of data to the plurality of retailers. In particular embodiments, the system may be configured to transmit the second set of data on a particular date, for example, the first day of every month.

MAP Compliance Policing Module

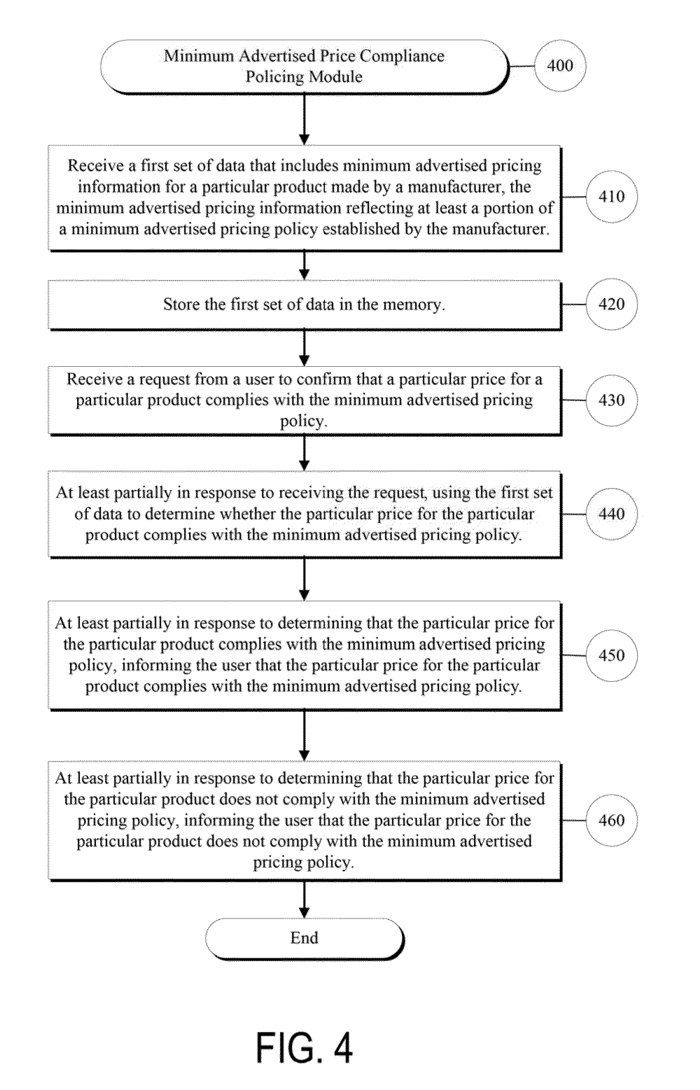

FIG. 4 is a flow chart of operations performed by an exemplary MAP Compliance Policing Module 400, which may, for example, run on the MAP Compliance Server 100, or any suitable computing device. In particular embodiments, the MAP Compliance Policing Module 400 may store MAP compliance data and inform a user as to whether a particular price violates a MAP policy.

Beginning at Step 410, the system receives a first set of data that includes MAP information for a particular product made by a manufacturer, the MAP information reflecting at least a portion of a MAP policy established by the manufacturer. In particular embodiments, the system may be configured to receive the first set of data from any suitable computing device. In various embodiments, the MAP policy may, for example, have been established by a manufacturer of the particular product. In particular embodiments, the MAP information may include, for example, a MAP for the particular product for a particular geographical area. In various embodiments, the MAP information may include, for example, a MAP for the particular product for a particular time period. For example, the MAP for a particular product may be set at $150 for the period between June 1 and July 31 and $125 for the period between August 1 and September 30. Thus, the first set of data may include information such as price, date, geographic area, etc. for the MAP of the particular product.

At Step 420, the system continues by storing the first set of data in the memory. In various embodiments, the system may be configured to substantially automatically store the first set of data in the memory.

Continuing to Step 430, the system receives a request from a user to confirm that a particular price for a particular product complies with the MAP policy. In various embodiments, the user is a competitor of a retailer that is offering the particular product at the particular price. For example, the user may want to confirm that its own price for a particular product complies with the MAP policy. In addition, the user may want to confirm that a competitor's price for a particular product complies with the MAP policy. In various embodiments, the request from the user may be to confirm that a proposed pricing structure would comply with the MAP policy. In particular embodiments, the request from the user may also be a request to notify the manufacturer of a violation of a MAP policy by the user.

Next, at Step 440, the system, at least partially in response to receiving the request from Step 430, uses the first set of data to determine whether the particular price for the particular product complies with the MAP policy. In various embodiments, the system may compare the particular price with a MAP established by the MAP policy and in response to the particular price being greater than or equal to the MAP, determine that the particular price for the particular product complies with the MAP policy. In particular embodiments, the system may compare the particular price with a MAP established by the MAP policy and in response to the particular price being less than the MAP, determine that the particular price for the particular product does not comply with the MAP policy.

The system continues at Step 450 by, at least partially in response to determining that the particular price for the particular product complies with the MAP policy, informing the user that the particular price for the particular product complies with the MAP policy. In various embodiments, the system may inform the user that the particular price for the particular product complies with the MAP policy via an electronic communication generated by the system. In some embodiments, the electronic communication may be substantially simultaneously to the request by the user. In other embodiments, the electronic communication may be by e-mail, text message, automated phone call, instant message or by any other suitable means of electronic communication.

At Step 460, the system, at least partially in response to determining that the particular price for the particular product does not comply with the MAP policy, informs the user that the particular price for the particular product does not comply with the MAP policy. In various embodiments, the system may inform the user that the particular price for the particular product does not comply with the MAP policy via an electronic communication generated by the system. In particular embodiments, after informing the user that the particular price does not comply with the MAP policy, the system may receive a dispute from the user disputing the violation of the MAP policy.

MAP Compliance Reporting and Enforcing Module

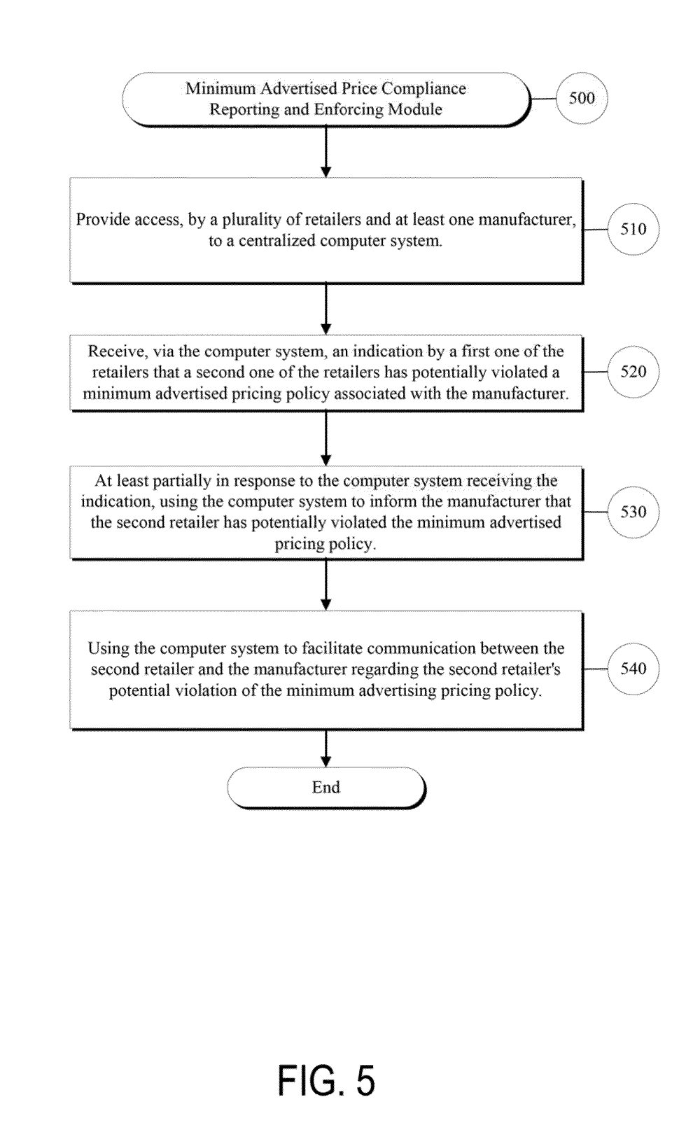

FIG. 5 is a flow chart of operations performed by an exemplary MAP Compliance Reporting and Enforcing Module 500, which may, for example, run on the MAP Compliance Server 100, or any suitable computing device. In particular embodiments, the MAP Compliance Reporting and Enforcing Module 500 may facilitate reporting and enforcing of MAP policies.

To begin with, at Step 510, the system provides access, by a plurality of retailers and at least one manufacturer, to a centralized computer system. Access to the computer system may be provided through the Internet, a LAN, a WAN, or any other suitable network that is adapted to facilitate communication between the retailers and the at least one manufacturer.

Continuing to Step 520, the system receives, via the computer system, an indication by a first one of the retailers that a second one of the retailers has potentially violated a MAP policy associated with the manufacturer. In particular embodiments, the indication may be an electronic communication between the first retailer and the system regarding the second retailer's alleged violation of the MAP policy.

At Step 530, the system, at least partially in response to the computer system receiving the indication, uses the computer system to inform the manufacturer that the second retailer has potentially violated the MAP policy. In various embodiments, the system may inform the manufacturer of the second retailer's violation by electronic communication. For example, after receiving the indication from the first retailer, the system may send the first retailer's note directly to the manufacturer. In other embodiments, the system may inform the manufacturer using a pop-up notification, e-mail notification, an instant message, a text message, an automated phone message where the user presses a key to indicate that the understand the message, or any other suitable means of electronic communication.

Following Step 530, at Step 540, the system uses the computer system to facilitate communication between the second retailer and the manufacturer regarding the second retailer's potential violation of the MAP policy. In various embodiments, the system may facilitate communication by electronic communication. Such communications may include, for example: (1) a communication from the manufacturer to the second retailer that includes the MAP policy and the alleged violation of the MAP policy including the actual price used by the second retailer for the particular product; (2) a communication from the second retailer to the manufacturer that includes the second retailer's position as to why the second retailer's pricing of the particular product does not violate the manufacturer's MAP policy; and (3) a response to this communication from the manufacturer as to whether the manufacturer still believes, after reviewing the communication from the second retailer, that the second retailer's pricing of the item violates the manufacturer's MAP policy for the particular item. This step allows the second retailer and the manufacturer to resolve any alleged MAP violations. Following the resolution of the second retailer's alleged MAP violation, in various embodiments, the system may inform the first retailer as to the outcome of the communications between the second retailer and the manufacturer regarding the second retailer's alleged violation of the MAP policy.

MAP Compliance Monitoring Module

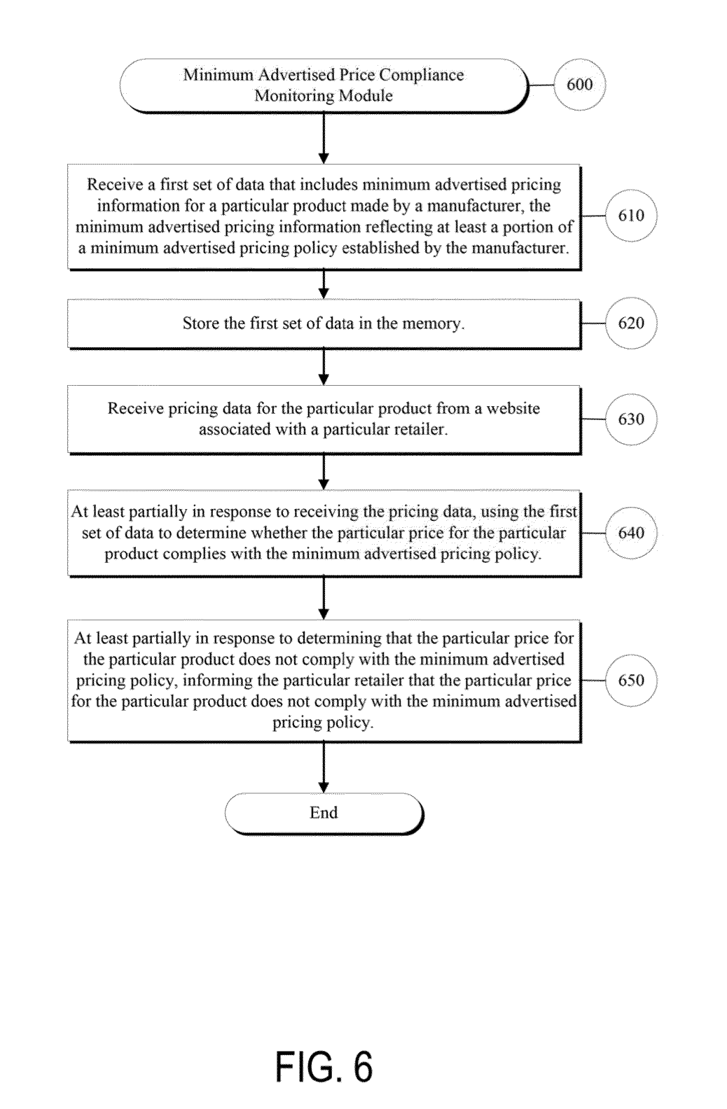

FIG. 6 is a flow chart of operations performed by an exemplary MAP Compliance Monitoring Module 600, which may, for example, run on the MAP Compliance Server 100, or any suitable computing device. In particular embodiments, the MAP Compliance Monitoring Module 600 may store MAP compliance data, directly monitor compliance with MAP policies, and facilitate enforcement of MAP policies.

In various embodiments, the system begins at Step 610 by receiving a first set of data that includes MAP information for a particular product made by a manufacturer, the MAP information reflecting at least a portion of a MAP policy established by the manufacturer. In particular embodiments, the system may be configured to receive the first set of data from any suitable computing device. In various embodiments, the MAP policy may, for example, have been established by a manufacturer of the particular product. In particular embodiments, the MAP information may include, for example, a MAP for the particular product for a particular geographical area. In various embodiments, the MAP information may include, for example, a MAP for the particular product for a particular time period. For example, the MAP for a particular product may be set at $100 for the period between June 1 and July 31 and $85 for the period between August 1 and September 30. Thus, the first set of data may include information such as price, date, geographic area, etc. for the MAP of the particular product.

At Step 620, the system stores the first set of data in the memory. In various embodiments, the system may be configured to substantially automatically store the first set of data in the memory.

Next, at Step 630, the system receives pricing data for the particular product from a website associated with a particular retailer. In particular embodiments, the system may receive general pricing data from the retailer's website by conducting a search on the retailer's website for the particular product from any computer. In various embodiments, the system may receive pricing data using a computer located in a particular region to access the website. For example, some retailers may offer one or more products at different prices based at least in part on a location from which a customer's computer accesses the retailer's website. In such embodiments, the system may be configured to provide pricing information to the manufacturer that includes the pricing information for the one or more regions or geographic locations.

Continuing to Step 640, the system, at least partially in response to receiving the pricing data, uses the first set of data to determine whether the particular price for the particular product complies with the MAP policy. In various embodiments, the system may compare the particular price with a MAP established by the MAP policy and in response to the particular price being greater than or equal to the MAP, determine that the particular price for the particular product complies with the MAP policy. In particular embodiments, the system may compare the particular price with a MAP established by the MAP policy and in response to the particular price being less than the MAP, determine that the particular price for the particular product does not comply with the MAP policy. In various embodiments where the system obtains different retailer pricing based on differing geographic access points, the system may be configured to check each price against the MAP policy since the MAP policy may contain different price points based on geographic location.

At Step 650, at least partially in response to determining that the particular price for the particular product does not comply with the MAP policy, informing the particular retailer that the particular price for the particular product does not comply with the MAP policy. In various embodiments, the system may inform the user that the particular price for the particular product does not comply with the MAP policy via an electronic communication generated by the system. In particular embodiments, the system may inform the retailer about all MAP violations at the same time, for instance, at the end of every day, or in the alternative, the system may notify the retailers of MAP noncompliance substantially automatically when a price does not comply. In various embodiments, the system may bundle all non-complying prices for all products into a single notification to the retailer. In other embodiments, the system may show all prices that comply with a MAP policy in green and all prices that do not comply with a MAP policy in red so that the user can easily distinguish those prices in compliance from those prices that are out of compliance. In various embodiments, the system may be configured to automatically monitor the particular price for the particular product at present intervals, continuously or manually. In any case, the system may be configured to notify the retailer when the system detects that the particular price for the particular product is not in compliance with the MAP policy.

Exemplary User Interface

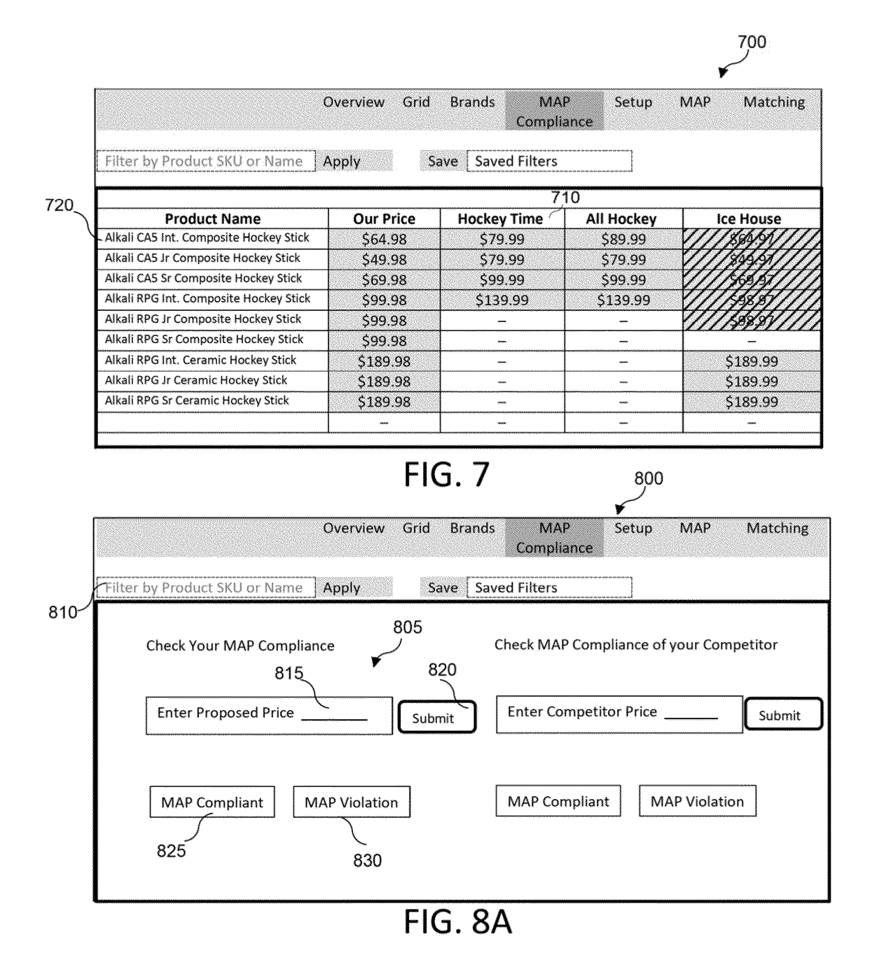

FIG. 7 depicts a user interface 700 that a user may use to confirm compliance with one or more MAP policies. As may be understood from this figure, the interface 700 may include one or more competitor columns 710 that the user may use to confirm whether one or more particular competitors are complying with a particular MAP policy for a particular product. In particular embodiments, the interface 700 may further include a color scheme using red (shown by the cross hatched lines) for noncompliance and green (shown as shaded) for compliance, which corresponds generally to the colors of a stop light, and allow the user to quickly assess the overall compliance with a particular MAP policy for a particular product. For example, the first row 720 shows that the user's company is currently charging $64.98 for the product Alkali CA5 Int. Composite Hockey Stick, while the competitor Hockey Time is charging $79.99 and the competitor Ice House is charging $64.97 for the product. Also, assume the manufacturer has set a MAP of $64.98 in the manufacturer's MAP policy. Because the competitor Hockey Time's price is above the particular MAP, the competitor's price is shown shaded. However, because the competitor Ice House's price is below the particular MAP, the competitor's price is shown with cross hatching. In this way, the user can easily identify pricing that is compliance and pricing that violates the manufacturer's MAP.

### Exemplary User Experience

MAP Compliance Communication Module User Experience

The following describes an exemplary user experience using the MAP Compliance Communication Module 300. To begin with, a manufacturer will have an established MAP policy that will designate a particular MAP for a particular product. For instance, the manufacturer, Acme Bats may have a product, the Bomber 2000, with a nationwide MAP policy for the bat of $49.99. The manufacturer, by accessing the MAP Compliance Server 100 will enter the MAP policy into the system using their computer (e.g., a manufacturer's computer, such as manufacturer computer 154 shown in FIG. 1). The system will store the particular MAP policy of $49.99 for the Bomber 2000 as well as send out a notification of the current MAP via the one or more networks 115 to all the retailers currently selling the Bomber 2000. The retailers would then be able to see the MAP for the Bomber 2000 by logging onto their computer (e.g., a retailer's computer, such as retail computer 152 shown in FIG. 1).

If the manufacturer decides to update the MAP for the Bomber 2000, for instance to lower the price of the MAP, the manufacturer may log onto the system and access the MAP Compliance Server 100 in the same way as before. The manufacturer may then enter the new MAP policy of $39.99, for example using their computer. Once the manufacturer has changed the MAP from $49.99 to $39.99 MAP, the system will automatically send out a notification of the new MAP to all the retailers selling the particular product. The retailers may receive this notification the next time they log onto the system or via email depending upon the retailer's preferences. Using this system, for example, the manufacturer may raise or lower the MAP, discontinue using the MAP, or change other specifics related to the MAP such as geographic information or dates. Because this is an automatic update to all of the retailer's user interfaces, retailers currently selling the particular product will not have to search for the current MAP for the particular product.

MAP Compliance Policing Module User Experience

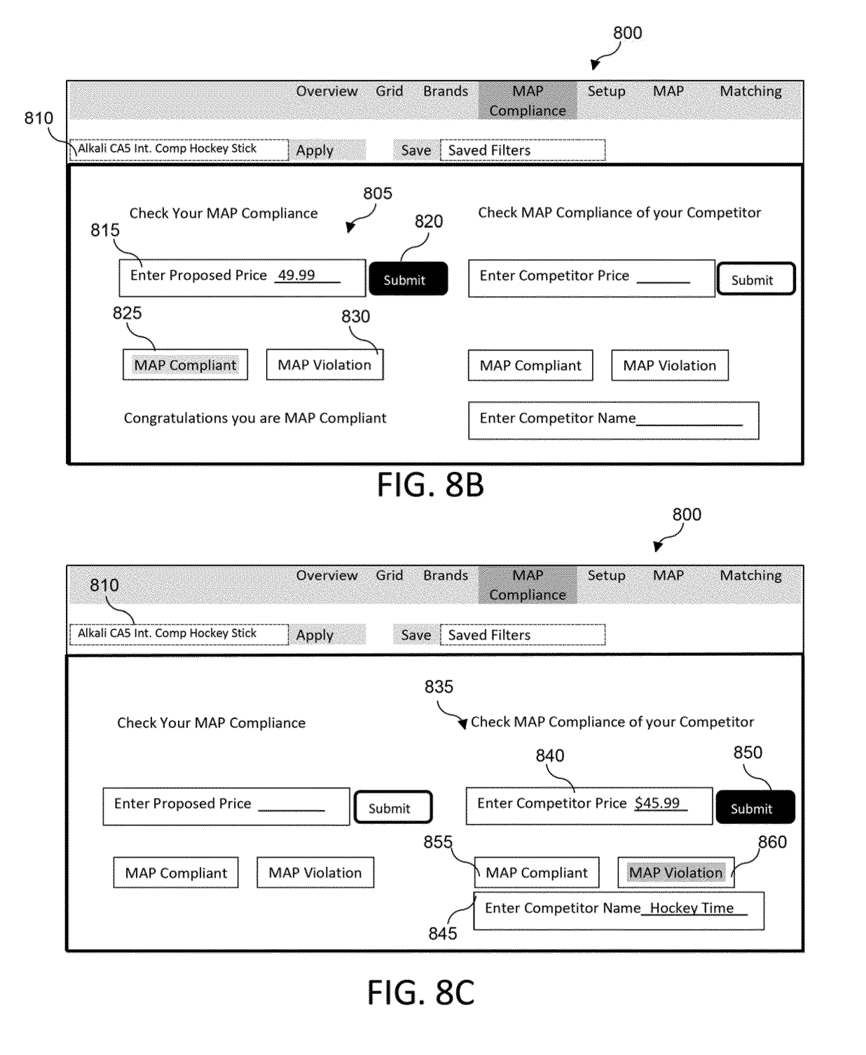

The following describes an exemplary user experience using the MAP Compliance Policing Module 400. Using this module allows retailers looking to raise or lower the price of a particular product, for example the Alkali CA5 Int. Comp Hockey Stick, to confirm that the new price will comply with the manufacturer's MAP policy. For example, a particular sporting goods retailer, Hockey R Us, may wish to sell the Alkali CA5 Int. Comp Hockey Stick made by the manufacturer Alkali. Hockey R Us may wish to offer the Alkali CA5 Int. Comp Hockey Stick at a very low “loss leader” price in order to attract more customers to its store. For instance, Hockey R Us is currently selling the Alkali CA5 Int. Comp Hockey Stick for $64.98 but would like to lower its price to attract customers away from its competitor, Hockey Time. Using this system and referring to FIG. 8A, an employee of Hockey R Us is able to log onto the system using the store's computer (e.g., a retailer's computer, such as retailer computer 152 shown in FIG. 1) and open a user interface 800. The User interface 800 has a first section 805 that allows a retailer to check its compliance with a manufacturer's MAP. In particular, first section 805 has a product entry field 810, a proposed price entry field 815, a submit button 820, a MAP Compliant indicator 825 and a MAP Violation indicator 830. Referring to FIG. 8B, the Hockey R Us employee may then enter the new desired price, $49.99, for the Alkali CA5 Int. Comp Hockey Stick into the system and hit the submit button 820. Because the manufacturer, Alkali, set the MAP for the Alkali CA5 Int. Comp Hockey Stick at $49.99, the system will notify the retailer that the new price complies with the MAP policy highlighting the MAP Compliant indicator 825 as shown in the figure. In addition, this module enables the retailer to enter any price, whether current, proposed, or that of a competitor, to determine whether the price complies. The system also allows the retailer to set up notifications for instances where the retailer's price or the competitor's price falls below the manufacturer's MAP.

MAP Compliance Reporting and Enforcing Module User Experience

The following describes an exemplary user experience using the MAP Compliance Reporting and Enforcing Module 500. This feature of a particular embodiment enables a first retailer to police the prices used by a second retailer and allows the first retailer to report a potential violation of a MAP policy by the second retailer. For example, Hockey R Us may have seen an ad by its competitor, Hockey Time, listing the Alkali CA5 Int. Comp Hockey Stick for $45.99. Because Hockey R Us also sells the Alkali CA5 Int. Comp Hockey Stick, it may wish to confirm that Hockey Time is complying with Alkali's MAP policy for the Alkali CA5 Int. Comp Hockey Stick. Using the system, a Hockey R Us employee may log onto the system and be directed to a user interface 800 shown in FIG. 8C that has a second section 835 that allows the user to check the compliance of a competitor to a manufacturer's MAP policy. Using this user interface, the Hockey R Us employee may enter the product name, Alkali CA5 Int. Comp Hockey Stick, in the product name entry field 810. The employee also enters the competitor's price, $45.99, in the price field 840 and the competitor's name, Hockey Time, in the name field 845. Once the data is entered, the user selects the submit button 850 to send the data to the system for analysis. In this example, because Hockey Time's price is below Alkali's MAP for the Alkali CA5 Int. Comp Hockey Stick, the MAP Violation indicator 860 is highlighted while the MAP compliance indicator 855 is not. The system may then provide the option to Hockey R Us to notify Alkali of Hockey Time's potential violation, or in other embodiments, the system may automatically send Alkali the information when a MAP violation is detected. The system will then allow Alkali to open up a communication box between itself and Hockey Time to resolve the violation. Hockey Time may respond to this communication directly or may respond indirectly by changing its price for the Alkali CA5 Int. Comp Hockey Stick. Once the violation has been resolved, Alkali may close the communication box and may select whether it wants to send the resolution of the violation to the notifying retailer, Hockey R Us.

MAP Compliance Monitoring Module User Experience

The following describes an exemplary user experience using the MAP Compliance Monitoring Module 600. In this embodiment, the system automatically monitors the pricing of particular products offered by a particular retailer on the retailer's website. For example, the MAP Compliance Server 100 will access the one or more networks 115 and perform a search for a specific retailer's website, for instance Hockey R Us and Hockey Time. If after accessing the retailers' websites, the system determines that Hockey Time is selling the Alkali CA5 Int. Comp Hockey Stick for $45.99 and Hockey R Us is selling the Alkali CA5 Int. Comp Hockey Stick for $49.99, while Alkali's MAP policy for the Alkali CA5 Int. Comp Hockey Stick is $49.99, the system will automatically generate a notification to Hockey Time and the communication process discussed above will ensue until the violation is resolved.

Finally, a retailer may use the system to retrieve a full listing of all of its products in a certain area to make sure that there are no holes in the retailer's inventory. For instance, using the user interface 700 shown in FIG. 7, Hockey R Us may access the grid showing all of Hockey R Us' products in the first column 730, Hockey R Us' prices in the second column 740, and all competitors selling the same products in the following columns. After running the search for its products, if the first column displays a line for a particular product, Hockey R Us will be able to update the pricing for that particular product.

Exemplary Advantages of Various Embodiments

Certain embodiments may have particular advantages to one or more retailers or manufacturers. However, not all advantages will be duly applicable to all users or in all situations. The following discusses advantages that may be realized by some manufacturers using particular embodiments. First, the system will allow manufacturers to detect source MAP violations, which will help to improve the quality of MAP enforcement and will make finding such violations easier for the manufacturers. In addition, certain embodiments will allow manufacturers to quickly and effectively update and distribute changes to MAP policies to all retailers using a single computer system.

Similarly, certain embodiments may have particular advantages to one or more retailers. For instance, certain retailers may find certain embodiments to be an effective platform for reporting competitors' violations of MAP policies. Other retailers may find that certain embodiments provide a beneficial platform for quickly and effectively addressing and resolving their own potential MAP violations. Still other retailers may find that certain embodiments provide an effective platform for keeping up to date on manufacturers' product lines and MAP policies. Each of these various advantages will create a more centralized and more effective process that will in turn enable better policing, monitoring, communication, and enforcement regarding manufacturers' MAP policies.

### CONCLUSION

Many modifications and other embodiments of the invention will come to mind to one skilled in the art to which this invention pertains having the benefit of the teachings presented in the foregoing descriptions and the associated drawings. For example, instead of having a separate user interface 800 that allows the user to enter pricing to check compliance with a MAP, the user may engage the user interface 700 for reporting MAP violations. In particular, when a price is shown with cross hatching (e.g., is red), the user may click on that particular pricing to send a note to the manufacturer. Additionally, an additional column may be added to the user interface 700 that allows a user to input a proposed price for a particular item, which then causes the system to check the proposed price against the manufacturer's MAP policy for that item. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

1. A computer system for managing compliance with one or more minimum advertised pricing policies, the system comprising:
a. at least one processor; and
b. memory, wherein said computer system is configured for:
i. receiving a first set of data that includes minimum advertised pricing information for a particular product made by a manufacturer, the minimum advertised pricing information reflecting at least a portion of a minimum advertised pricing policy established by the manufacturer;
ii. storing the first set of data in said memory;
iii. receiving a request, from a user, to confirm that a particular price for a particular product complies with the minimum advertised pricing policy;
iv. at least partially in response to receiving the request, using the first set of data to determine whether the particular price for the particular product complies with the minimum advertised pricing policy;
v. at least partially in response to determining that the particular price for the particular product complies with the minimum advertised pricing policy, one of:
informing the user that the particular price for the particular product complies with the minimum advertised pricing policy; and
informing the user that the particular price for the particular product does not comply with the minimum advertised pricing policy.

2. The computer system of claim 1, wherein the step of using the first set of data to determine whether the particular price for the particular product complies with the minimum advertised pricing policy comprises:
a. comparing the particular price with a minimum advertised price established by the minimum advertised pricing policy; and
b. in response to the particular price being greater than or equal to the minimum advertised price, determining that the particular price for the particular product complies with the minimum advertised pricing policy.

3. The computer system of claim 1, wherein the step of receiving the first set of data comprises receiving the first set of data from the manufacturer.

4. The computer system of claim 3, wherein the user is a retailer that is offering the particular product for sale at the particular price.

5. The computer system of claim 3, wherein the user is a competitor of a retailer that is offering the particular product at the particular price.

6. The computer system of claim 1, wherein the computer system is adapted for allowing the manufacturer to electronically update the minimum advertised pricing policy.

7. The computer system of claim 1, wherein the computer system is adapted for:
a. receiving, from the manufacturer, a request to notify a particular retailer of an alleged violation, by the retailer, of a minimum advertised pricing policy associated with the manufacturer; and
b. at least partially in response to receiving the request, notifying the particular retailer of the alleged violation.

8. The computer system of claim 7, wherein the computer system is adapted for:
a. after the step of notifying the particular retailer of the particular retailer's violation of the minimum advertised pricing policy, receiving, from the particular retailer, a dispute of the manufacturer's assertion that the particular retailer has violated the minimum advertised pricing policy; and
b. at least partially in response to receiving the dispute, notifying the manufacturer of the dispute.

9. A method of enforcing a minimum advertised pricing policy, the method comprising:
a. providing access, by a plurality of retailers and at least one manufacturer, to a centralized computer system;
b. receiving, via the computer system, an indication, by a first one of the retailers, that a second one of the retailers has potentially violated a minimum advertised pricing policy associated with the manufacturer;
c. at least partially in response to the computer system receiving the indication, using the computer system to inform the manufacturer that the second retailer has potentially violated the minimum advertised pricing policy; and
d. using the computer system to facilitate communication between the second retailer and the manufacturer regarding the second retailer's potential violation of the minimum advertised pricing policy.

10. The method of claim 9, further comprising informing the first retailer as to an outcome of communications between the second retailer and the manufacturer regarding the second retailer's potential violation of the minimum advertised pricing policy.

11. The method of claim 9, wherein the step of receiving an indication further comprises:
a. presenting, by the computer system, to the first one of the retailers a listing of products;
b. presenting, by the computer system, to the first retailer at least one respective price for each product in the listing of products for the second retailer; and
c. providing a link, by the computer system, that is configured to allow the first retailer to select a particular one of the listing of products where the second retailer is in violation of the manufacturer's minimum advertised pricing policy.

12. The method of claim 9, wherein the step of informing the manufacturer further comprises sending an electronic communication to the manufacturer.

13. The method of claim 12, wherein the communication is chosen from a group consisting of:
a. an e-mail message;
b. a text message;
c. a pop-up message; and
d. an instant message.

14. The method of claim 9, wherein the step of using the computer system to facilitate communication between the second retailer and the manufacturer further comprises generating an electronic communication exchange between the second retailer and the manufacturer.

15. The method of claim 14, wherein the electronic communication exchange is carried out using a communication method chosen from a group consisting of:
a. e-mail;
b. text messaging;
c. automated phone call; and
d. instant messaging.

16. A computer system for managing compliance with one or more minimum advertised pricing policies, the system comprising:
a. at least one processor; and
b. memory, wherein said computer system is configured for:
i. receiving a first set of data that includes minimum advertised pricing information for a particular product made by a manufacturer, the minimum advertised pricing information reflecting at least a portion of a minimum advertised pricing policy established by the manufacturer;
ii. at least partially in response to receiving the first set of data:
storing the first set of data in said memory; and
transmitting the first set of data to a plurality of retailers that are currently selling the product;
iii. receiving a second set of data that includes updated minimum advertised pricing information for the particular product;
iv. at least partially in response to receiving the second set of data:
storing the second set of data in said memory; and
transmitting the second set of data to a plurality of retailers that are currently selling the product.

17. The computer system of claim 16, wherein the computer system is adapted for:
a. receiving a request, from a first one of the plurality of retailers, to confirm that a particular price for a particular product complies with a minimum advertised price contained in the second set of data;
c. at least partially in response to receiving the request from the first one of the plurality of retailers, comparing the particular price with the minimum advertised price; and
b. in response to the particular price being greater than or equal to the minimum advertised price, determining that the particular price for the particular product complies with the second set of data.

18. The computer system of claim 16, wherein the computer system is adapted for generating a table that comprises:
a. a listing of products from the manufacturer;
b. a corresponding price for each one of the products for at least a first retailer; and
c. an indication of whether the listed price is greater than or equal to a minimum advertised price associated with one of the first set of data and the second set of data.

19. The computer system of claim 18, wherein the generated table further comprises a corresponding price for each one of the products for a second retailer and a link that is configured to allow the first retailer to submit a potential minimum advertised price violation to the manufacturer.

20. The computer system of claim 19, wherein the computer system is further adapted to notify the manufacturer of a potential minimum advertised price violation when the link is activated by the first retailer.

21. The computer system of claim 16, wherein the computer system is adapted for:
a. automatically monitoring a price of a particular product offered by one or more of the plurality of retailers;
b. determining when the price of the particular product for at least one of the one or more of the plurality of retailers is less than one of the minimum advertised pricing information and the updated minimum advertised pricing information; and
c. notifying the at least one of the one or more of the plurality of retailers that its price of the particular product is less than the one of the minimum advertised pricing information and the updated minimum advertised pricing information.
